(19) United States
(12) Patent Application Publication
(10) Pub. No.: US 2026/0227260 A1
(43) Pub. Date: Aug. 6, 2026

(54) METHOD FOR COMPENSATING FOR A TEMPERATURE SHOCK ON A CAPACITIVE PRESSURE-MEASURING CELL

(71) Applicant: IFM ELECTRONIC GMBH, Essen (DE)

(72) Inventors: Manfred MAURUS, Bad Waldsee (DE); Peter KIMBEL, Tettnang (DE); Tim HECKENBERGER, Tettnang (DE)

(73) Assignee: IFM ELECTRONIC GMBH, Essen (DE)

(21) Appl. No.: 19/152,907

(22) PCT Filed: Feb. 2, 2024
(86) PCT No.: PCT/EP2024/052602

§ 371 Date: Jul. 31, 2025

(30) Foreign Application Priority Data
Feb. 7, 2023 (DE) 10 2023 102 928.2

(51) Int. Cl. G01L 9/12; G01L 9/00; G01L 27/00

(52) U.S. Cl. CPC G01L 9/125; G01L 9/0075; G01L 27/002; G01L 27/007

(57) ABSTRACT

A method compensates for a temperature shock on a capacitive pressure-measuring cell includes a measuring capacitor and a reference capacitor. A measured pressure value p is obtained by forming the quotient from the capacitance values from the reference capacitor and the measuring capacitor, and a measured pressure value p_{M} is obtained using the measuring capacitor, wherein the temperature shock is identified by comparing the measured pressure values p and p_{M}, and the gradient dD of the difference value D between both values is monitored for exceeding a predefined threshold value. The method includes storing a first correction factor k₁ in a lookup table in a calibration procedure; continuously recording and analyzing the difference D; multiplying the identified difference value D with the first correction factor k₁ and adding it to the measured pressure value p; and outputting this corrected measured pressure value for further processing.

The invention relates to a method for compensating for a temperature shock on a capacitive pressure-measuring cell.

Capacitive pressure sensors or pressure-measuring devices are used in many industrial sectors to measure pressure. They often have a ceramic pressure-measuring cell as a measuring transducer for the process pressure, and evaluation electronics for signal processing.

Capacitive pressure-measuring cells consist of a ceramic base body and a membrane, wherein a glass solder ring is arranged between the base body and the membrane. The resulting cavity between the base body and the membrane enables the longitudinal mobility of the membrane as a result of pressure influence. This cavity is therefore also referred to as the measuring chamber. Electrodes are provided on the underside of the membrane and on the opposite upper side of the base body, which electrodes together form a measuring capacitor. The application of pressure causes the membrane to deform, which results in a change in the capacitance of the measuring capacitor.

With the help of an evaluation unit, the change in capacitance is recorded and converted into a measured pressure value. These pressure sensors are usually used to monitor or control processes. They are therefore often connected to higher-level control units (PLCs).

From DE 198 51 506 C1 a capacitive pressure sensor is known, in which the measured pressure value is determined from the quotient of two capacitance values, which values are from a measuring capacitor and a reference capacitor. Although this patent does not specifically describe a pressure-measuring cell, the circuit shown and the method described are suitable for capacitive pressure-measuring cells. The special feature of this pressure-measuring device is that, for the evaluation of the measurement signal at the output, as a measure of the recorded measured pressure value, only the amplitude of the square-wave signal is relevant, regardless of its frequency.

A circuit arrangement for a capacitive pressure sensor is known from EP 0 569 573 B1, in which a quotient method is also used for pressure evaluation.

Quotient methods generally assume the following pressure dependencies:

$$p ∼ \frac{{C}_{R}}{{C}_{M}} or p ∼ \frac{{C}_{R}}{{C}_{M}} - 1 or p ∼ \frac{{C}_{M} - {C}_{R}}{{C}_{M} + {C}_{R}} ,$$

wherein C_{M} is the capacitance of the measuring capacitor, C_{R} is the capacitance of the reference capacitor, and p is the process pressure to be determined. It is also conceivable to swap C_{M} and C_{R} in the quotient. The given example with C_{M} in the denominator, however, represents the most common form in favor of self-linearization. In the following, this embodiment will be assumed unless otherwise stated.

Furthermore, it is well known, for example from DE 10 2011 005 705 B4, that the temperature prevailing during the pressure measurement, in particular that of the medium to be measured, can have a very significant influence on the accuracy of the measured results. For this reason, the temperature is also measured in parallel to the pressure measurement by means of a temperature element arranged on the back of the base body, so that the temperature dependence of the pressure measurement can be compensated for.

However, a rapid change in temperature, i.e. a so-called thermal shock, represents a challenge, which can lead to tension in the membrane of the pressure-measuring cell. The tensions in the membrane result from a temperature difference between a medium acting on the membrane of the pressure-measuring cell and the base body of the pressure-measuring cell, which faces away from the medium and is thermally connected to the environment.

Against this background, the EP 2 189 774 A1 is based on the finding that pressure-induced deformation of the membrane differs from thermal shock-induced membrane deformation in terms of measurement technology. The method disclosed therein for identifying rapid temperature changes is based on the fact that, for measured values of the measuring capacitance Cm, the measured values of the reference capacitance Cr are compared with expected values of the reference capacitance Cr which are derived from the measured values of the measuring capacitance Cm, and wherein a temperature jump is identified if the measured value of the reference capacitance lies outside a tolerance range around an expected value. However, this method assumes that a rapid temperature change is the sole cause of the observed discrepancy between the measured values and the expected values. However, this is not always the case in practice. For example, in the event of mechanical damage to the pressure-measuring cell, particularly the membrane, a comparable effect would occur between the measured and expected values, which would then lead to the erroneous assumption that an acting temperature would have to be compensated for, instead of replacing the pressure-measuring cell or ultimately the entire pressure-measuring device, since the output pressure measurement values would very likely no longer correspond to the actual pressure conditions.

EP 2 726 833 B1 also discloses a method in which the value pairs of the two capacitances are monitored within a predefined tolerance range to determine whether they correspond to the relationship of a predefined function.

EP 3 124 937 B1 discloses a method for temperature compensation based on the temperature difference between the membrane and the base body of the pressure-measuring cell. To measure the temperature, a temperature sensor is arranged on the membrane and on the base body, respectively. The disadvantage here, however, is the significant delay, which is due to the natural inertia of temperature sensors, which means that the actual compensation method also starts with a delay. However, the temperature-related error influence on the measurement result is greatest immediately after the occurrence of a temperature shock, as is known to the applicant from DE 102020 122 128 B3.

The object of the invention is to start the temperature compensation very early after a temperature shock and thereby to significantly reduce the temperature-related measurement error.

The object is achieved according to the invention by a method having the features of claim 1. Advantageous embodiments of the invention are specified in the dependent claims.

The invention is based on the method disclosed by the applicant in DE 102020 122 128 B3, according to which a comparison of the two values of the quotient Q and the capacitance value of the measuring capacitor C_{M} results in switching to a kind of “alarm state” at a very early stage if this comparison deviates from an expected behavior. Specifically, in this comparison, the gradient dD of the difference value D between the measured pressure value p formed by the quotient and the pressure value p_{M} formed by the measuring capacitor C_{M} is monitored for exceeding a threshold value. Preferably, the measured pressure values p and p_{M} have been previously linearized. The advantage over a pure difference evaluation is that gradual changes, such as aging effects or tensions that build up or decrease within the pressure-measuring cell due to various causes, are ignored by the gradient and only rapid changes are reacted to.

According to the invention, a first correction factor k₁ is initially stored in a lookup table during a calibration procedure. This correction factor k was determined empirically and depends largely on the structure and geometry of the pressure-measuring cell. Corresponding tests have shown that this correction factor k₁ is approximately identical across all pressure-measuring cells, despite different nominal pressure ranges and correspondingly slightly modified structures, which makes the method much easier.

After activation of the “alarm state”, the difference D between the two measured pressure values p and p_{M} is continuously recorded and evaluated. Preferably, the difference D is also stored as a bias immediately after activation of the “alarm state”, in order to compensate for any gradual effects that may have occurred. The permanently determined, if necessary advantageously bias-corrected difference values D are each multiplied by the correction factor k₁ from the lookup table and added to the measured pressure value p. Investigations have shown that it is advantageous to continuously record the difference D between the measured pressure values p and p_{M}, and then to multiply the factor k₁ by the determined difference value D, i.e., to weight it, and then to add this calculated value to the measured pressure value p.

This measured pressure value, now corrected to compensate for the temperature influence, is temporarily output for further processing, instead of the actual measured pressure value p. Temporary means, for example, as long as the gradient dD of the difference value D between the measured pressure values p and p_{M} exceeds the above-mentioned threshold value.

Alternatively, instead of the first correction factor k₁, a correction curve created during a calibration procedure and stored in a lookup table can also be used.

The advantage of the invention is that the compensation of the temperature shock initially takes place without the involvement of a temperature element, since at this early stage a temperature element cannot yet respond due to its natural inertia. The temperature-related error influence on the measurement result is at its greatest immediately after the occurrence of a temperature shock.

In a further development, the pressure-measuring cell advantageously has a temperature element and the gradient dT of this temperature element is recorded and evaluated. This provides the advantageous possibility of carrying out a plausibility check to determine whether a temperature-related error influence, i.e. a temperature shock, actually exists. The absence of a temperature change recorded by the temperature element would trigger an error handling process by generating an error signal, since an error has been detected, the cause of which is initially unknown.

A further advantageous development provides for a switch to a second temperature compensation stage as soon as the difference value D no longer exceeds a predefined threshold value. In this second compensation stage, the existing gradient dT of the temperature element is then multiplied by a second correction factor k₂ stored in the lookup table, and added to the measured pressure value p. For further processing, this currently corrected measured pressure value is then used instead of the previous corrected measured pressure value.

Advantageously, the temperature compensation is terminated and the original measured pressure value p, formed by the quotient Q, is output when the temperature gradient dT falls below a predefined threshold value.

The invention is explained in more detail below using exemplary embodiments with reference to the drawings.

In the figures:

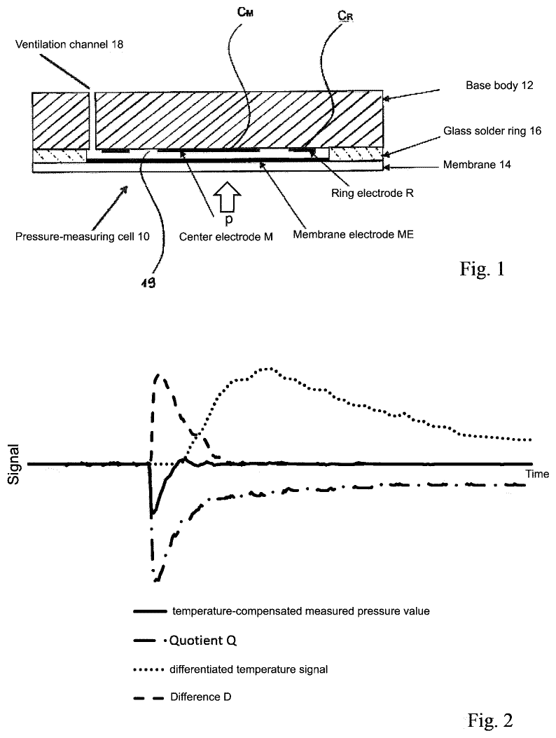

FIG. 1 is a schematic sectional view of a capacitive pressure-measuring cell,

FIG. 2 is a diagram illustrating an exemplary course of the temperature-compensated measured pressure value, the quotient Q, the difference value D, and a differentiated temperature signal over time in the case of a temperature shock without external pressure influence.

In the following description of the preferred embodiments, the same reference signs denote the same or comparable components.

FIG. 1 shows a schematic representation of a typical capacitive pressure-measuring cell 10, as is widely used in capacitive pressure-measuring devices. The pressure-measuring cell 10 substantially consists of a base body 12 and a membrane 14, which are connected to each other via a glass solder ring 16. The base body 12 and the membrane 14 define a cavity 19, which—preferably only at low pressure ranges up to 50 bar—is connected to the rear side of the pressure-measuring cell 10 via a ventilation channel 18.

Several electrodes are provided both on the base body 12 and on the membrane 14, which electrodes form a reference capacitor C_{R} and a measuring capacitor C_{M}. The measuring capacitor C_{M} is formed by the membrane electrode ME and the center electrode M, and the reference capacitor C_{R} is formed by the ring electrode R and the membrane electrode ME.

The process pressure p acts on the membrane 14, which bends more or less depending on the pressure applied, wherein the distance between the membrane electrode ME and the center electrode M substantially changes. This leads to a corresponding change in the capacitance of the measuring capacitor C_{M}. The influence on the reference capacitor C_{R} is lower because the distance between the ring electrode R and the membrane electrode ME changes less than the distance between the membrane electrode ME and the center electrode M.

In the following, no distinction is made between the designation of the capacitor and its capacitance value. C_{M} and C_{R} therefore designate both the measuring capacitor or reference capacitor, respectively, and the capacitance of each.

FIG. 2 shows a diagram of how the curves of the temperature-compensated measured pressure value, the quotient Q, the difference value D, and the differentiated signal of the temperature element could look over time in the case of a temperature shock without external pressure influence. In this case, the quotient Q, which corresponds to the measured pressure value p and is formed from the capacitance values of the reference capacitor C_{R} and the measuring capacitor C_{M}, is shown as a dash-dotted line, and the difference value D between the measured pressure value p and the measured pressure value p_{M} obtained only from the measuring capacitor C_{M} is shown as a dashed line. Furthermore, the differentiated signal of the temperature element is shown as a dotted line, and the temperature-compensated measured pressure value, which is output by means of the method according to the invention for further processing, for example, to a control device, is shown as a solid line.

The temperature shock starts at the point where the signals of the quotient Q, the difference D, and the compensated measured pressure value abruptly swing downwards or upwards. It can be seen with what significant delay the temperature element reacts to the temperature influence. However, this strong temperature change is immediately “detected” in the capacitance values of the measuring and reference capacitors, with the reference capacitor showing a significantly stronger signal deflection than the measuring capacitor.

This phenomenon is already known from the initially sited EP 2 189 774 B1 and DE 102020 122 128 B3.

Since FIG. 2 does not show external pressure influence, the target measured pressure value, i.e., the quotient Q, should actually be constant on the abscissa, i.e., the zero line. This is clearly not the case and illustrates the enormous influence of the temperature change caused by the shock.

If the signal curves are considered against the background that the abscissa represents the ideal line for a measured pressure value, the following also becomes apparent. On the one hand, when comparing the (uncompensated) quotient Q with the measured pressure value compensated by the method according to the invention, the significantly lower signal deflection is recognizable, whereby the absolute measurement error immediately after the temperature shock is also correspondingly significantly lower due to the method according to the invention. On the other hand, it can be seen that the measured pressure value compensated for by the method according to the invention returns to the ideal line very quickly and thus correctly assumes the value zero, while the uncompensated quotient value is still subject to a measurement error until the end of the diagram.

The trigger for the method according to the invention is the exceeding of a predefined threshold value of the gradient dD of the difference value D between the measured pressure value p, which is formed by the quotient Q from the capacitance values of the reference capacitor C_{R} and the measuring capacitor C_{M}, and the pressure value p_{M}, which is obtained only from the measuring capacitor C_{M}. If this threshold value is exceeded, an “alarm state” is activated and the compensation method according to the invention is started. In this case, it is also advantageous to observe more closely the signal curve of a temperature element, which is advantageously located on the pressure-measuring cell 10, to see whether the assumed temperature shock is confirmed by a significant increase in the gradient dT of the temperature element. If this is not the case, this plausibility check can first generate an error signal and search for another cause of the error.

As soon as the temperature element confirms the temperature shock, a second temperature compensation stage can be activated. The switching point would preferably be at the point when the difference value D no longer exceeds a predefined threshold value. In this second compensation stage, instead of the difference value D based on the capacitances C_{M} and C_{R}, the gradient dT of the temperature element is used. The compensation method can be terminated and the measured pressure value p formed by the quotient Q can be output again when the temperature gradient dT falls below a predefined threshold value.

### LIST OF REFERENCE SIGNS

10 pressure-measuring cell
12 base body
14 membrane
16 glass solder ring
18 ventilation channel
19 cavity
C_{M} measuring capacitor
C_{R} reference capacitor
Q quotient
p measured pressure value, formed by the quotient Q
p_{M} measured pressure value, formed by the measuring capacitor C_{M}
D difference between measured pressure value p and measured pressure value p_{M}
M center electrode
R ring electrode
ME membrane electrode

1. A method for compensating for a temperature shock on a capacitive pressure-measuring cell, which has a measuring capacitor (C_{M}) and a reference capacitor (C_{R}), and, in an evaluation unit, a measured pressure value p is obtained by forming the quotient Q from the capacitance values of the reference capacitor (C_{R}) and the measuring capacitor (C_{M}), and a measured pressure value p_{M} is obtained using the measuring capacitor (C_{M}),
wherein the temperature shock is identified by comparing the measured pressure values p and p_{M} with each other and the gradient dD of the difference value D of both values is monitored with regard to whether a predefined threshold value is exceeded,
characterized by the following method steps:
in a calibration procedure, storing a first correction factor k₁ in a lookup table;
continuously recording and evaluating the difference D;
multiplying the determined difference value D by the first correction factor k₁ and adding the result of the multiplying step to the measured pressure value p to determine a corrected measured pressure value; and
outputting the corrected measured pressure value for further processing.

2. The method according to claim 1,
wherein the pressure-measuring cell has a temperature element and the gradient dT of the temperature element is recorded and evaluated.

3. The method according to claim 2,
wherein a plausibility check is performed by confirming the temperature shock in the case of an increase in the gradient dT of the temperature element, and by generating an error signal in the case of an unchanged gradient of the temperature element.

4. The method according to claim 2,
wherein a switch is made to a second temperature compensation stage as soon as the difference value D no longer exceeds a predefined threshold value, wherein the existing gradient dT of the temperature element is then multiplied by a second stored correction factor k₂ and added to the measured pressure value p to determine the corrected measured pressure value, and then the corrected measured pressure value is output for further processing.

5. The method according to claim 2,
wherein the compensation is terminated and the original measured pressure value p formed by the quotient Q is output when the temperature gradient dT falls below a predefined threshold value.

6. The method according to claim 1,
wherein the current difference D is stored as a bias at the time of identification of the temperature shock.
